(19) United States
(12) Patent Application Publication
(10) Pub. No.: US 2022/0268668 A1
(43) Pub. Date: Aug. 25, 2022

(54) Pneumatic Aggregate Sample Device

(71) Applicant: Charlie Cross, Odenville, AL (US)

(72) Inventor: Charlie Cross, Odenville, AL (US)

(21) Appl. No.: 17/676,619

(22) Filed: Feb. 21, 2022

Related U.S. Application Data
(60) Provisional application No. 63/151,526, filed on Feb. 19, 2021.

(51) Int. Cl. G01N 1/14

(52) U.S. Cl. CPC G01N 1/14; G01N 2001/1463

(57) ABSTRACT

The present invention comprises an aggregate sample device comprising an air compression system mounted to one side of an aggregate conveyor belt frame. Mounted on the opposite side of the conveyor is a crossover housing that is joined to a discharge chute. The compression system is comprised of a compressor that charges an air tank. Projecting out of the air tank is a air discharge line that has on its terminal head a nozzle which is inserted into an aperture located in an end plate of the crossover housing such that the nozzle is in direct proximity to aggregate traveling on an aggregate conveyor. The compression system is charged such that the air tank reaches an ideal pressure and then an operator deploys a switch which releases a volume of air at high pressure such that a sample of aggregate on the conveyor is blown off the conveyor, constrained by the crossover housing and directed into the discharge chute where the aggregate is directed downward into a sample receptacle.

### CROSS-REFERENCED TO RELATED APPLICATIONS

This application claims the benefit of priority to Provisional Application No. 63/151,526 filed on Feb. 19, 2021.

### FEDERALLY SPONSORED RESEARCH

None

### SEQUENCE LISTING

None

### FIELD OF THE INVENTION

The present invention relates to a pneumatically operated aggregate sample device designed to be used to remove aggregate samples from a conveyor seamlessly without halting the conveyor and also without damaging the conveyor.

### BACKGROUND OF THE INVENTION

The aggregate industry commonly refers to four general groups of crushed stone which are limestone, granite, and traprock. The stones and derivates of them are quarried at various deposits all of the United States as well as the world. An aggregate plant takes quarried stones and reduces the stone size through crushing processes into smaller uniform sizes of stone that are used for various different applications. To ensure that the crushed aggregate is the appropriate uniform size upon leaving the crushing process, samples must be frequently taken off of a conveyor to ensure that the correct size aggregate product is exiting on the conveyor. If the aggregate is leaving the crushing process improperly sized, the aggregate plant operators will be required to make changes in the crushing process to ensure that the aggregate is properly sized. Sampling aggregate off of a conveyor requires an operator to shut down the entire aggregate plant to take a sample. If the aggregate plant were not to be shut down, aggregate would mound up at the crushing process and damage other processing equipment in the plant. Aggregate is sampled a number of times a day which shuts down an aggregate plant an hour at a time due to the plant having to be shut down, retrieving an aggregate sample off of a conveyor belt and then getting all systems online and running again. This can cost an aggregate plant a large amount of money and financial strain due to lost time of operation of the aggregate plant. What is needed in the art is a sample device that allows for continuous operation of an aggregate plant without need for shutting down the aggregate plant. Further, what is needed in the art is an aggregate sampling device that can remove a sample of aggregate off of a moving conveyor belt without coming into physical contact with the conveyor thereby not damaging the conveyor built.

### SUMMARY OF THE INVENTION

The present invention comprises an aggregate sample device comprising an air compression system mounted to one side of an aggregate conveyor belt frame. Mounted on the opposite side of the conveyor is a crossover housing that is joined to a discharge chute. The compression system is comprised of a compressor that charges an air tank. Projecting out of the air tank is a air discharge line that has on its terminal head a nozzle which is inserted into an aperture located in an end plate of the crossover housing such that the nozzle is in direct proximity to aggregate traveling on an aggregate conveyor. The compression system is charged such that the air tank reaches an ideal pressure and then an operator deploys a switch which releases a volume of air at high pressure such that a sample of aggregate on the conveyor is blown off the conveyor, constrained by the crossover housing and directed into the discharge chute where the aggregate is directed downward into a sample receptacle.

### BRIEF DESCRIPTION OF THE DRAWINGS

FIG. 1 is a front elevation of the pneumatic aggregate sample device.

FIG. 2 is a side elevation of the pneumatic aggregate sample device showing the air compression storage system.

FIG. 3 is a front perspective view of the pneumatic aggregate sample device mounted onto a pre-existing conveyor belt frame.

FIG. 4 is a side perspective view of the nozzle inserted into the end plate of the crossover housing.

FIG. 5 is a top plan view of the nozzle.

FIG. 6 is a perspective view of the discharge chute and the crossover housing.

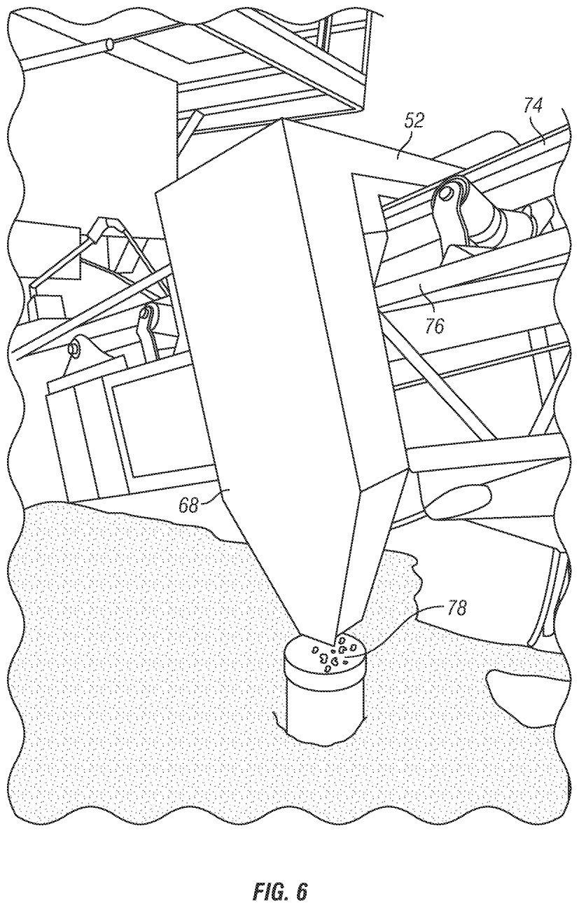

FIG. 7 is a front elevation showing the compression system.

FIG. 8 is a side view of the aggregate sample device.

FIG. 9 is an overhead perspective of view of the aggregate sample device.

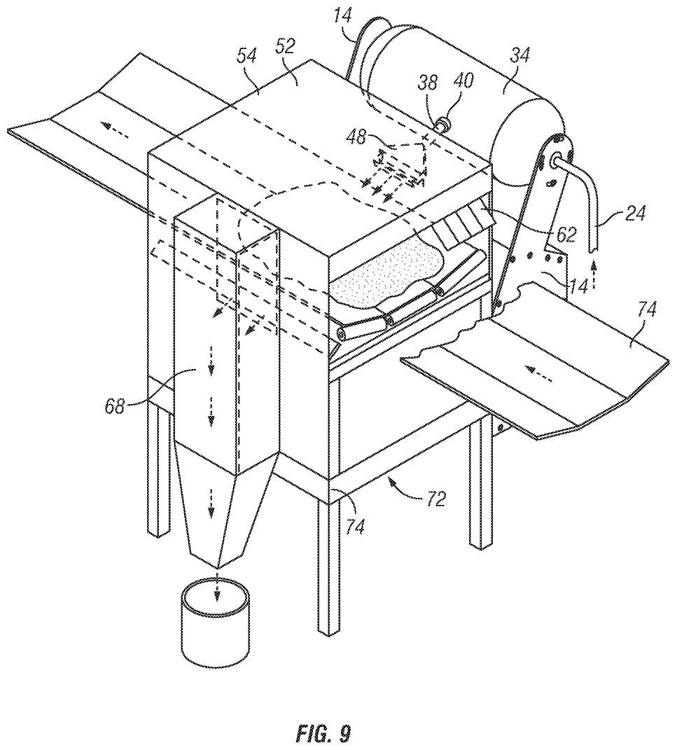

### DETAILED DESCRIPTION

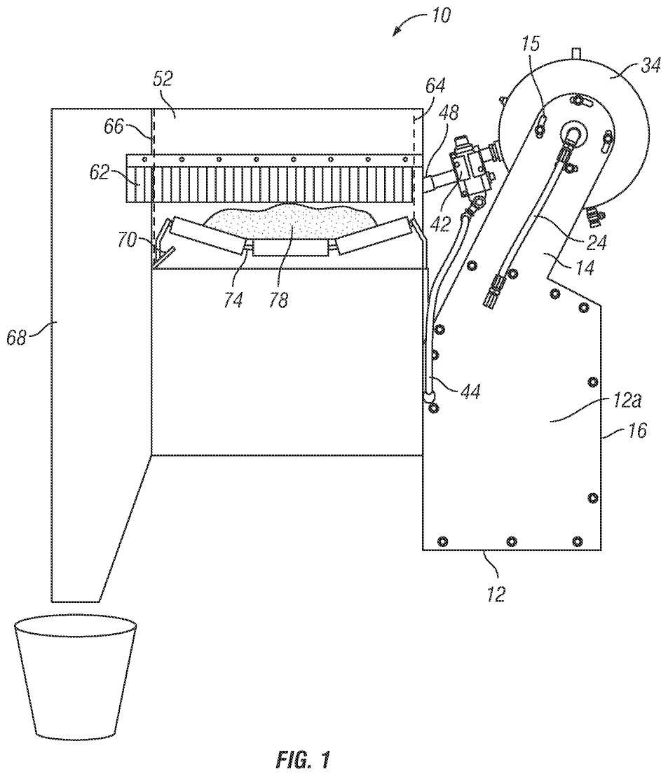

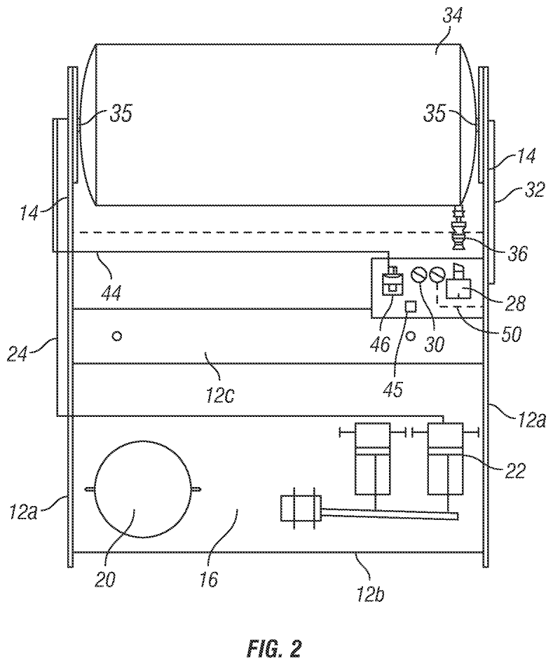

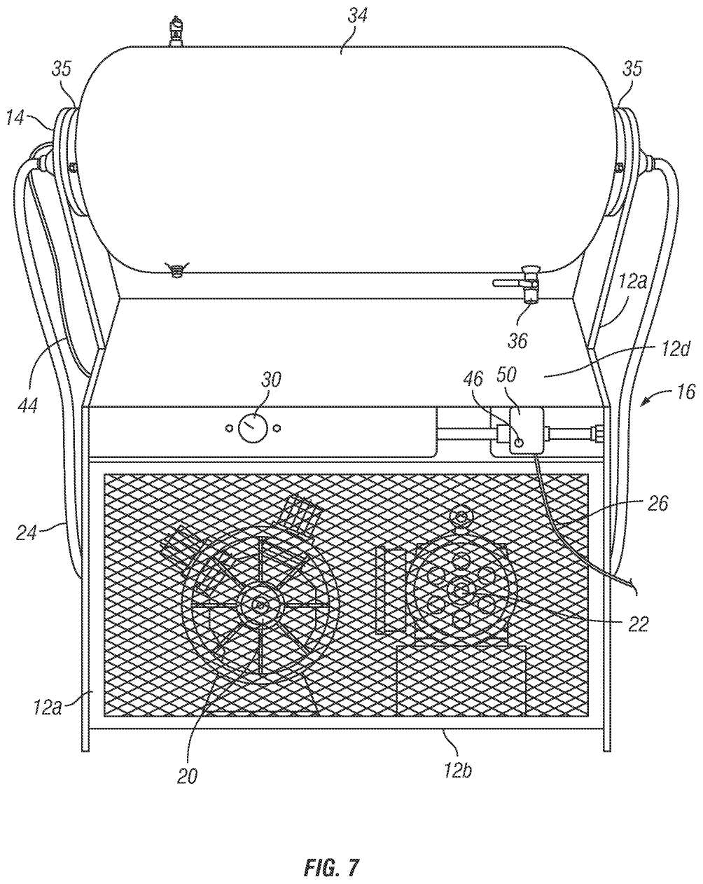

Referring now to FIG. 1 there is shown a pneumatic aggregate sample device 10 comprising an air compression storage system 16 mounted to one side of an aggregate conveyor frame. Across and directly on the opposite side of the conveyor is a channel unit comprising a crossover housing 52 that is substantially parallel to the conveyor belt 74 and covers an area directly above the conveyor belt 74 that is integrated into a vertically disposed discharge chute 68 that is mounted to said opposite side of the conveyor. The crossover housing has a top plate 54, left plate 56, right plate 56 and an end plate 58 and is generally rectangular in shape. The discharge chute 68 acts as a cantilever to support the crossover housing 52 located directly above the conveyor belt 74. The discharge chute 68 is rectangular in shape and narrows at its bottom region to funnel a sample of aggregate into a sample receptacle. The compression system 16 as shown in FIGS. 2 and 7 is mounted in a compression system sub-assembly frame 12 that consists of side plates 12a, a bottom plate 12b, a back plate 12c and a top plate 12d. The sub-assembly frame 12 is comprised side plates 12a, a bottom plate 12b, a back plate 12c and a top plate 12d and are bolted together to form the sub-assembly frame 12. There is also a gate protects the components of the compression system 16 which can be open or shut. The compression system 16 is comprised of a motor than runs a two-stage compressor that charges an air tank 34 that is supported by two tank arms 14 extend upwards from the side plates 12a. On either end of the air tank 34 is a mounting flange 35 welded to the tank having bolt apertures. Corresponding to the mounting flanges 35 and bolt apertures are mounting slots 15 located in the upper regions of the tank arms 14. The mounting slots 15 are curvilinear and allow the air tank 34 to rotate 5 degrees either way during the mounting process such as to get a proper alignment of the air tank 34 with the crossover housing 52. There is a tank 34 pressure line 32 connected to the tank 34 that is connected to an electronic pressure regulator 28. Connected to the air compressor is an air supply line 24 that is connected to the air tank 34 that allows the tank 34 to pressurized. The motor 20 and compressor 22 operate off a power source 26 and when the device 10 is turned on the tank is pressurized. On a control panel 50 are located pressure gauges 30 which monitor the compressor and the tank. Further located on the control panel is a pressure switch 46. On the front side of the air tank 34 facing the aggregate conveyor is a threaded aperture 40 that is mated with an air discharge line 38 which advances to an air nozzle 48. In line on the air discharge line 38 is a high speed gate valve 42 between the nozzle 48 and the air tank 34 that is electronically controlled by the pressure switch 46 or via a remote controlled transmitter that communicates with a receiver 45 electrically connected to the pressure switch 46. Said pressure switch 46 on the control panel 50 is connected by an electrical wire 44 to a moment switch on the high-speed gate valve 42. When the tank 34 is pressurized to an appropriate pressure, an operator will press the pressure switch 46 which evacuates the air in the air tank 34 and forces it through the nozzle 48 into the crossover housing 52 and violently blows the aggregate off the conveyor belt 74 through the crossover housing 52 and into the discharge chute 68 and into a sample bin whereby an operator will measure the size of the aggregate. Operationally, a 30 gallon air tank and a tank pressure of 150 pounds per square inch is a preferred embodiment and a two second burst with that pressure will blow an adequate amount of aggregate off of the conveyor belt 74 for a proper size sample. However, lower and potentially higher pressures can be employed. Further, plant air that is supplied by the aggregate facility could also be employed to pressurize the air tank 34 and would negate the need for a localized compression system as described above.

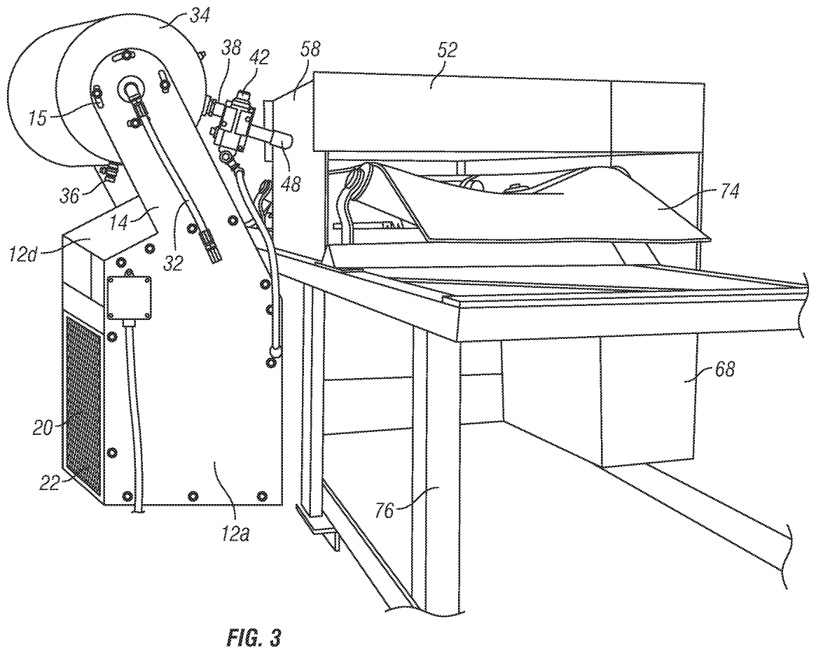

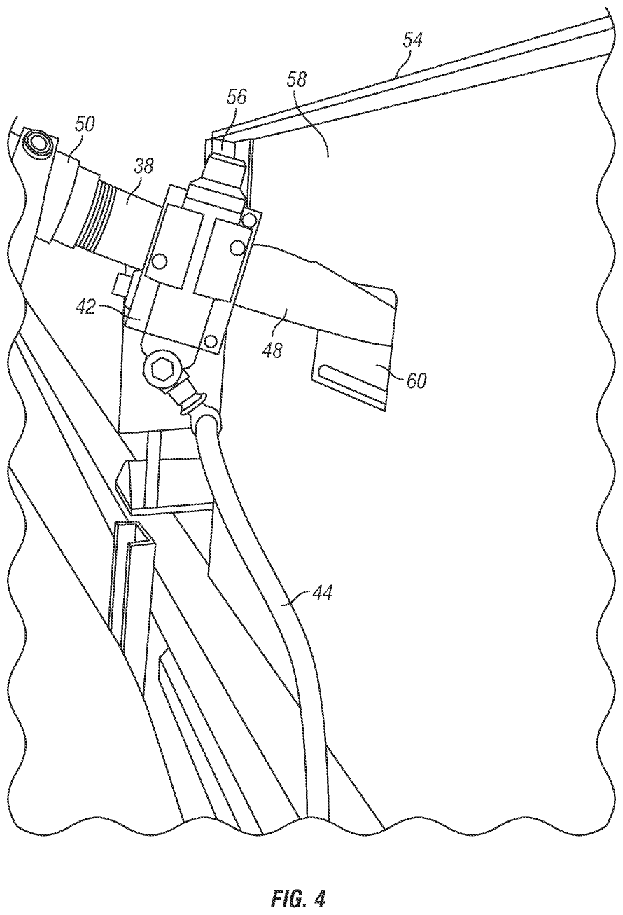

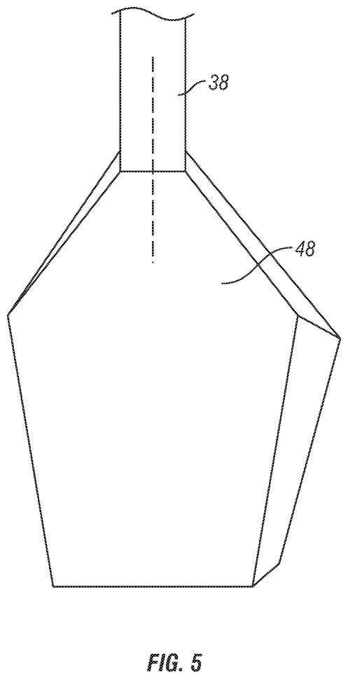

Turning now to FIGS. 3-5, there is shown where the nozzle 48 enters the crossover housing 52 through an aperture 60 on an end plate 58 of the crossover housing 52. The crossover housing aperture 60 should be large enough to insert the nozzle 48 into the crossover housing 52 but no larger than necessary so that any blow back of aggregate does not damage the aggregate sample device 10 or injure an operator. The nozzle as depicted in FIGS. 4-5 shows a nozzle 48 that is wider than taller which helps create a plane of violent air that advances across a wider area of the belt to get enough aggregate for a sample as opposed to a narrow nozzle which would not have as great of an effect due to the lack of wideness of the air flow path. Additionally, FIG. 5 shows a top plan view of the nozzle 48 which shows a widening flare of the left and right sides of the nozzle where it joins the air discharge line 38 and then a gentle tapering of the left and ride sides of the nozzle 48 as they approach the mouth of the nozzle which aids in pressurizing the air to get a more forceful and violent air current into the crossover housing 52. Additionally, the nozzle 42 not only horizontally tapers towards its approach to the nozzle 48 mouth but the top plate and bottom plate of the nozzle taper as they approach the mouth of the nozzle.

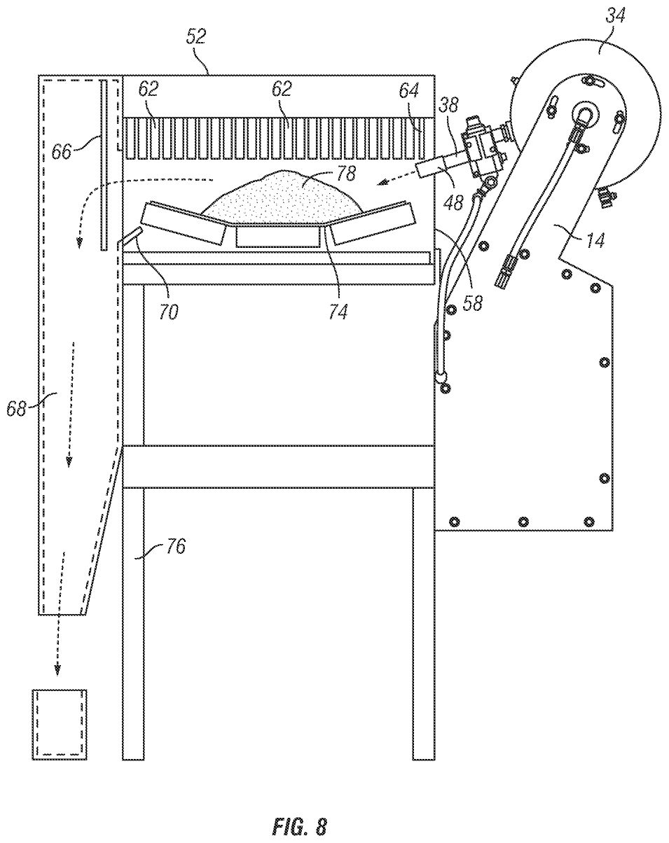

Referring now to FIGS. 1 and 8 there is shown on the interior of the crossover housing 52 a back plate 64 that is disposed directly above where the nozzle 48 protrudes into the crossover housing 52. The back plate is welded to the top plate 54, left plate 56 and right plate 56 of the crossover housing 52 and is perpendicular to the top plate 54 of the crossover housing 52 and extends vertically downward to where it almost touches the nozzle 48. The back plate 64 serves to protect the sample device 10 and an operator for damage or injury. The back plate 64 also serves to intensify the effectiveness of a blast of air from the nozzle 48 by reducing the amount of air that can escape from the aperture 60 in the end plate 58 of the crossover housing. The back plate 64 further serves to provide strength and rigidity to the crossover housing 52 by acting as a brace.

Also shown in FIGS. 1 & 8 is an impact curtain 66 that extends downward from the top of the discharge chute 68 directly adjacent to the conveyor belt 74. The impact curtain 66 is made of rubber and is semi-rigid and is designed so that when a blast of air from the nozzle 48 hurls aggregate into the into the discharge chute 68 it will flex and allow the aggregate to enter the discharge chute 68, but the impact curtain 66 will immediately retreat to its stationary position and prevent any aggregate from re-entering the crossover housing 52 as well preventing aggregate from getting into the rollers and mechanical parts of the conveyor. The impact curtain 66 also prevents the aggregate from slamming violently into the discharge chute 68 by acting as a semi-brake so that the outer wall of the discharge chute 68 does not receive the entire force of the collision of the aggregate and thereby preventing damage to the discharge chute and the sampling device as whole. A slope plate 70 is shown that is connected to the discharge chute 68 and projects at a generally 45 degree angle in towards the conveyor belt 74 such that it shields the conveyor belt 74 and its rollers from any aggregate that might otherwise enter the area of the working parts of the conveyor belt 74.

Also shown in FIGS. 1 and 8 are rubber skirts that hang down from the left side plate 56 and the right side plate 56 of the crossover housing 52. While shown residing slightly above the aggregate in FIGS. 1 and 8 for purposes of illustrating the belt 74 and the aggregate in the drawings, the rubber skirts 62 would extend almost all the way down to the belt 74. The rubber skirts 62 are purposed to prevent aggregate from being expelled when a blast of air from the nozzle 48 is introduced to the crossover housing 52. In a preferred embodiment, the rubber skirts 62 would be placed on the inner surface of either the left or right side plate 56 (depending on how the sample device is mounted on a conveyor) where aggregate enters and on the outside of the left or right side plate 62 of the crossover housing 52 where aggregate exits. This configuration allows the rubber skirts to more easily flex to allow aggregate to pass through the crossover housing unimpeded.

The discharge chute 68, crossover housing 52 and compression system sub-assembly 12 are made of metal and preferably steel. The pneumatic aggregate sample device saves aggregate producers time, money, and man-power by drastically reducing the amount of time testing of aggregate sample size has taken up to this point.

The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

### ENUMERATED ELEMENTS OF THE INVENTION

10 Aggregate sample device
12 Compression system sub-assembly frame
12a Side plate
12b Bottom plate
12c Back plate
12d Top plate
14 Tank mount arms
15 Mounting slots
16 Compression system
18 Compression system housing
20 Motor
22 Two stage compressor
24 Air supply line
26 Power Source
28 Electronic pressure regulator
30 Pressure gauges
32 Tank pressure line
34 Air tank
35 Mounting flange
36 Drain valve
38 Air discharge line
40 Threaded aperture in tank
42 High speed gate valve
44 Electrical wire
45 Receiver for remote operation
46 Pressure switch
48 Nozzle
50 Control panel
51 Channel unit
52 Crossover housing
54 Top plate
56 Side plates
58 End plate
60 Housing aperture for nozzle
62 Rubber skirts
64 Back plate
66 Impact curtain
68 Discharge chute
70 Slope plate
72 Aggregate conveyor
74 conveyor belt
76 conveyor frame
78 aggregate

What I claim is:

1. A pneumatic aggregate sampling system comprising:
an air compression storage system comprising a power source, a motor, an air compressor and a tank whereby air is introduced into the tank for storage;
a threaded aperture in the tank whereby there is an air discharge line that is connected to the threaded aperture in the tank and a high speed gate valve in line with the air discharge line and a nozzle located at a terminal end of the air discharge line;
a crossover housing having a top plate, side plates and an end plate mountable to a belt conveyor sub-frame such that it is positioned directly above a belt conveyor that is conveying an aggregate material;
a crossover housing aperture located in the end plate of the crossover housing that is adapted to receive the nozzle that is connected to the air tank; and
a vertical discharge chute connected to the crossover housing located on the opposite side of the belt conveyor from the air compression storage system.

2. The pneumatic aggregate sampling system of claim 1 whereby the nozzle tapers down from where it is connected to the air discharge line to its terminal end and the terminal end of the nozzle is wider than it is tall.

3. The pneumatic aggregate sampling system of claim 2 whereby the air compression storage system is housed and supported by a sub-assembly frame further comprising a bottom plate, two side plates, a back plate and a top plate whereby the side plates have arms that extend upwards.

4. The pneumatic aggregate sampling system of claim 3 where the air tank has a circular flange with bolt apertures mounted on either end of the air tank and said bolt apertures correspond to curvilinear slots located in the upper regions of the side plate arms of the sub-assembly frame such that the tank can be mounted in between the side plate arms.

5. The pneumatic aggregate sampling system of claim 4 whereby the curvilinear slots allow the tank to be rotated five degrees to precisely mount the tank to adapt to various conveyor belt systems.

6. The pneumatic aggregate sampling system of claim 1 whereby the air tank has a 30 gallon capacity, the pressure is set to 150 pounds per square inch and the amount of time the high speed gate valve stays open is two seconds when the air compression system is actuated.

7. The pneumatic aggregate sampling system of claim 1 further comprising an electronic pressure regulating switch that sets the air tank pressure.

8. The pneumatic aggregate sampling system of claim 7 further comprising a long-range transmitter and receiver connected to the high-speed dump valve such that the pneumatic aggregate sampling system can be operated remotely.

9. The pneumatic aggregate sampling system of claim 1 further comprising a back plate in the interior of the crossover housing that is perpendicular to the top plate and side plates and extends downwards and directly over the nozzle and the crossover housing aperture to prevent blowback of aggregate on an operator.

10. The pneumatic aggregate sampling system of claim 1 further comprising an impact curtain that extends downward from the top of the discharge chute and directly adjacent to the conveyor belt.

11. The pneumatic aggregate sampling system of claim 1 further comprising rubber skirts that are locate on both of the crossover housing sides plates and extend downwards to the conveyor belt.

12. A pneumatic aggregate sampling system comprising:
an air nozzle adjacent to a conveyor belt that is carrying aggregate whereby said air nozzle supplies a high pressure burst of air into a crossover housing having a top plate, side plates and an end plate whereby said crossover housing is mountable to a belt conveyor sub-frame such that it is positioned directly above a belt conveyor that is conveying an aggregate material;
a crossover housing aperture located in the end plate of the crossover housing that is adapted to receive the nozzle that is connected to an air supply line; and
a vertical discharge chute connected to the crossover housing located on the opposite side of the belt conveyor from the air compression storage system.

13. The pneumatic aggregate sampling system of claim 12 whereby the nozzle tapers down from where its connection with the air supply line to its terminal end and the terminal end of the nozzle is wider than it is tall.

14. The pneumatic aggregate sampling system of claim 13 further comprising an electronically controlled high speed gate valve in line on the air supply line located before the air supply line reaches the nozzle.

15. The pneumatic aggregate sampling system of claim 14 further comprising a back plate in the interior of the crossover housing that is perpendicular to the top plate and side plates and extends downwards and directly over the nozzle and the crossover housing aperture to prevent blowback of aggregate on an operator.

16. The pneumatic aggregate sampling system of claim 15 further comprising an impact curtain that extends downward from the top of the discharge chute and directly adjacent to the conveyor belt.

17. The pneumatic aggregate sampling system of claim 16 further comprising rubber skirts that are locate on both of the crossover housing sides plates and extend downwards to the conveyor belt.

18. A method for sampling the size of aggregate traveling on a conveyor belt comprising the steps of:
providing a pneumatic aggregate sampling system further comprising an air nozzle adjacent to a conveyor belt that is carrying aggregate whereby said air nozzle supplies a high pressure burst of air into a crossover housing having a top plate, side plates and an end plate whereby said crossover housing is mountable to a belt conveyor sub-frame such that it is positioned directly above a belt conveyor that is conveying an aggregate material and a crossover housing aperture located in the end plate of the crossover housing that is adapted to receive the nozzle that is connected to an air supply line and a vertical discharge chute connected to the crossover housing located on the opposite side of the belt conveyor from the air nozzle;
attaching and positioning said pneumatic aggregate sampling system onto a conveyor belt sub-frame;
placing a sampling bin underneath the discharge chute;
operating an electronically controlled high speed gate valve in line on the air supply line located before the air supply line reaches the nozzle such that a sample of aggregate is blown off the conveyor belt and into the sampling bin; and
retrieving the sample of aggregate to test for size consistency.

19. The method of claim 18 further comprising the step of providing a localized air compression storage system comprising a power source, a motor, an air compressor and a tank whereby air is introduced into the tank for storage and a threaded aperture located in the tank whereby the air supply line that is connected to the threaded aperture in the tank and the high speed gate valve is in line with the air supply line and the nozzle is located at a terminal end of the air supply line and the air compression storage system is housed in and supported by a sub-assembly frame further comprising a bottom plate, two side plates, a back plate and a top plate whereby the side plates have arms that extend upwards.
